(19) United States
(12) Patent Application Publication
(10) Pub. No.: US 2010/0066736 A1
(43) Pub. Date: Mar. 18, 2010

(54) METHOD, INFORMATION STORAGE MEDIUM, AND GAME DEVICE

(75) Inventors: Norihiro NISHIMURA, Tokyo (JP); Satoshi FUKUDA, Honjo-shi (JP)

Correspondence Address: OLIFF & BERRIDGE, PLC, P.O. BOX 320850, ALEXANDRIA, VA, 22320-4850, US

(73) Assignee: NAMCO BANDAI GAMES INC., TOKYO (JP)

(21) Appl. No.: 12/552,599

(22) Filed: Sep. 2, 2009

(30) Foreign Application Priority Data
Sep. 16, 2008 (JP) 2008-237239

(51) Int. Cl. G06T 15/00

(52) U.S. Cl. 345/419

(57) ABSTRACT

In a first-person gun shooting game or the like, when the player has performed a shooting operation, a bullet is fired from a gun held by a player's character. When the bullet has hit an enemy character, the enemy character is damaged. The bullet that has hit the enemy character rebounds from the enemy character and hits another object (wooden box) positioned near the enemy character so that the other object breaks.

Japanese Patent Application No. 2008-237239 filed on Sep. 16, 2008, is hereby incorporated by reference in its entirety.

### BACKGROUND

The present invention relates to a method that generates an image of a three-dimensional virtual space in which a plurality of objects are disposed, and the like.

A game device has been known as an image generation device. A gun shooting game that allows the player to shoot an enemy character, a flight shooting game that allows the player to control a player's aircraft and attack an enemy aircraft by firing a missile or a cannon, and the like have been known. In such a game, when a bullet (attack object) has hit an attack target moving object, a bullet rebound effect (i.e., the bullet that has hit the attack target moving object rebounds from the attack target moving object) may be produced by changing the object of the bullet that has hit the moving object to a rebound object (see JP-A-09-81780, for example).

A shooting game is characterized in that an image that shows a state in which enemy characters are shot one after another is generated and displayed. A related-art shooting game is mainly designed so that the player shoots only enemy characters without shooting characters (e.g., citizen) other than the enemy characters. Specifically, the players generally compete for good reflexes, such as defeating a number of enemy characters within the time limit or defeating all enemy characters within a short time. Therefore, a related-art shooting game may not provide a refreshing shooting experience or may lack an attractive effect.

### SUMMARY

According to one aspect of the invention, there is provided a method of generating an image of a virtual three-dimensional space, a plurality of objects being disposed in the virtual three-dimensional space, the method comprising:

detecting that an attack object that flies in the virtual three-dimensional space has come in contact with an object among the plurality of objects; and

damaging another object among the plurality of objects that satisfies a given relative positional relationship with the object that has come in contact the attack object.

### BRIEF DESCRIPTION OF THE DRAWINGS

FIG. 1 schematically shows an example of an arcade game device.

FIG. 2 shows an example of a game screen.

FIG. 3 shows an example of a player's character.

FIGS. 4A to 4C show examples of a game screen.

FIGS. 5A and 5B are views illustrative of a rebound bullet target range.

FIG. 6 shows examples of parts that form a breakable object.

FIG. 7 is a view illustrative of stepwise breakage due to a bullet.

FIG. 8 is a view showing the functional configuration of a game device.

FIG. 9 shows a data configuration example of a breakable object list.

FIG. 10 shows a data configuration example of a rebound bullet count table.

FIG. 11 shows a data configuration example of a rebound bullet target range table.

FIG. 12 shows a data configuration example of hit effect data.

FIG. 13 is a flowchart of a shooting process.

FIGS. 14A and 14B show another example of a rebound bullet target range.

FIGS. 15A and 15B show another example of a rebound bullet target range.

FIGS. 16A and 16B show yet another example of a rebound bullet target range.

FIG. 17 schematically shows an example of a consumer game device.

FIGS. 18A to 18C show examples of a game screen of a flight shooting game.

FIG. 19 shows a modification of hit effect data.

### DESCRIPTION OF EXEMPLARY EMBODIMENTS

According to one embodiment of the invention, there is provided a program that causes a computer to generate an image of a virtual three-dimensional space, a plurality of objects being disposed in the virtual three-dimensional space, the program causing the computer to function as:

a detection section that detects that an attack object that flies in the virtual three-dimensional space has come in contact with an object among the plurality of objects;

a selection section that selects a damaging target object from objects among the plurality of objects that are positioned at a distance from the object that has come in contact with the attack object and satisfies a given relative positional relationship with the object that has come in contact with the attack object; and

a damaging section that damages the object selected by the selection section.

According to another embodiment of the invention, there is provided a game device that generates an image of a virtual three-dimensional space and executes a given game, a plurality of objects being disposed in the virtual three-dimensional space, the game device comprising:

a firing section that fires an attack object that flies in the virtual three-dimensional space based on an operation input by a player;

a detection section that detects that the attack object has come in contact with an object among the plurality of objects;

a selection section that selects a damaging target object from objects among the plurality of objects that are positioned at a distance from the object that has come in contact with the attack object and satisfy a given relative positional relationship with the object that has come in contact with the attack object; and

a damaging section that damages the object selected by the selection section.

According to the above configuration, when the attack object that flies in the virtual three-dimensional space has come in contact with an object among the plurality of objects, another object that is positioned at a distance from the object that has come in contact with the attack object and satisfies a given relative positional relationship with the object that has come in contact with the attack object is selected and damaged. Specifically, the other object that is positioned at a distance from the object that has come in contact with the attack object is secondarily damaged. For example, when executing a gun shooting game, the attack object that flies in the virtual three-dimensional space may be a bullet (e.g., missile) fired from a gun. In this case, an object that has come in contact with the bullet and another object that is positioned at a distance from the object that has come in contact with the bullet can be damaged. Therefore, a bullet rebound effect in which the bullet that has hit the object rebounds from the object and hits another object positioned nearby can be produced.

In the above program,

the damaging section may cause the other object to break when the other object selected by the selection section is a breakable object.

According to the above configuration, when the other object selected by the selection section is a breakable object, the other object is caused to break. Therefore, when executing a shooting game such as a gun shooting game, an attractive breakage effect in which the bullet that has hit the shooting target object rebounds from the object and hits another object positioned near the shooting target object can be produced. This implements a more interesting game.

In the above program,

an allowable damage level may be set corresponding to each of the plurality of objects;

the program may cause the computer to further function as a management section that decrements an allowable remaining damage level of an object among the plurality of objects that has been damaged; and

the damaging section may cause the other object to break when the allowable remaining damage level of the other object is equal to or less than a given damage level.

According to the above configuration, the other object selected as the damaging target object is caused to break when the allowable remaining damage level of the other object is equal to or less than the given damage level. The allowable remaining damage level is decremented each time the object is damaged. Specifically, a situation in which the object does not break when the object has been damaged once, but breaks when the object has been damaged a plurality of times, can be produced.

The above program may cause the computer to further function as:

a damage level determination section that determines the damage level applied to the object selected by the selection section, and

the damaging section may cause the object selected by the selection section to break when the allowable remaining damage level of the object selected by the selection section is equal to or less than the damage level determined by the damage level determination section.

According to the above configuration, the damage level applied to the other object selected as the damaging target object is determined, and the other object is caused to break when the allowable remaining damage level of the other object is equal to or less than the determined damage level. Specifically, the damage level applied to the object can be changed.

The above program may cause the computer to further function as:

a successive execution control section that causes the selection section to successively executes a selection process that selects an object among the plurality of objects that is positioned at a distance from the object that has been selected by the selection section and satisfies a given relative positional relationship with the object that has been selected by the selection section as a damaging target object, and causes the damage level determination section and the damaging section to operate each time the selection process is executed.

According to the above configuration, the process that selects the damaging target object and the process that damages the selected object are successively executed. Specifically, when the attack object has come in contact with the object, a plurality of objects are secondarily and successively damaged. Therefore, a successive bullet rebound effect in which the bullet that has hit the object successively rebounds and hits another object positioned nearby can be produced.

In the above program,

the damage level determination section may gradually reduce the damage level applied to the object successively selected under control of the successive execution control section each time the selection process is executed.

According to the above configuration, the damage level applied to the damaging target object is gradually reduced. Therefore, a bullet rebound effect in which the bullet weakly rebounds from the object each time a rebound occurs can be produced, for example.

In the above program,

the successive execution control section may stop the selection process based on the allowable remaining damage level of the object that has been damaged.

According to the above configuration, the selection process is stopped based on the allowable remaining damage level of the object that has been damaged. Therefore, the object is not secondarily and successively damaged when the object that has been secondarily damaged has broken, by stopping the selection process when the allowable remaining damage level is equal to or less than the given damage level, for example.

In the above program,

the damaging section may execute a breakage effect process on the object selected by the selection section taking account of a direction from the object that has come in contact with the attack object to the object selected by the selection section.

According to the above configuration, the breakage effect process on the other object is executed taking account of the direction from the object that has come in contact with the attack object to the object selected by the selection section. Therefore, a more natural breakage effect in which the other object breaks from the direction of the rebound bullet can be produced, for example.

In the above program,

the selection section may include a search range setting section that sets a search range having a given shape around the object that has come in contact with the attack object, and may select another object that is positioned within the search range.

According to the above configuration, the search range having a given shape is set around the object that has come in contact with the attack object, and another object that is positioned within the search range is selected. The search range corresponds to the range in which the object that has come in contact with the attack object can be secondarily damaged. Specifically, an object that is positioned near the object that has come in contact with the attack object is secondarily damaged, but an object that is positioned at a distance from the object that has come in contact with the attack object is not secondarily damaged. Therefore, a natural effect in which a bullet (attack object) rebounds from the object and hits another object positioned nearby can be produced, for example.

The above program may cause the computer to further function as:

a camera placement section that disposes a virtual camera in the virtual three-dimensional space; and

an image generation section that generates an image of the virtual three-dimensional space viewed from the virtual camera, and

the search range setting section may set the search range to be a cylindrical range that includes the object that has come in contact with the attack object and is disposed along a line-of-sight direction of the virtual camera.

According to the above configuration, the search range is set to be a cylindrical range that includes the object that has come in contact with the attack object and is disposed along the line-of-sight direction of the virtual camera. When the line-of-sight direction of the virtual camera aims at the object that has come in contact with the attack object, another object that is positioned within the field of view of the virtual camera (i.e., another object in the image generated based on the virtual camera) is secondarily damaged. Therefore, an image in which another object is secondarily damaged is generated.

In the above program,

the detection section may include a contact part detection section that detects a part of the object that has come in contact with the attack object; and

the search range setting section may change at least one of the size, shape, and direction of the search range corresponding to the part detected by the detection section.

According to the above configuration, the search range is changed corresponding to the part of the object that has come in contact with the attack object. For example, another object that is positioned near the part of the object that has come in contact with the attack object can be damaged by setting the search range near the part of the object that has come in contact with the attack object. Therefore, a natural effect in which a bullet (attack object) rebounds from the object and damages another object that is positioned near the part of the object that has come in contact with the bullet can be produced, for example.

In the above program,

the detection section may include a flight direction detection section that detects a flight direction of the attack object when the attack object has come in contact with the object; and

the search range setting section may change at least one of the size, shape, and direction of the search range corresponding to the flight direction detected by the flight direction detection section.

The flight direction is a direction in which the attack object flies. According to the above configuration, the search range is changed corresponding to the flight direction of the attack object when the attack object has come in contact with the object. For example, another object that is positioned to form a small angle with the flight direction can be damaged by setting a given angular range including the flight direction as the search range. Therefore, a natural effect in which a bullet (attack object) rebounds from the object in a direction close to the flight direction and damages another object that is positioned in the rebound direction, can be produced, for example.

In the above program,

a plurality of attack objects that differ in type may be provided; and

the search range setting section may change the size of the search range corresponding to the type of the attack object that has come in contact with the object.

According to the above configuration, the size of the search range is changed corresponding to the type of the attack object that has come in contact with the object. Therefore, the difference in power between the attack objects can be expressed (e.g., only a nearby object may be secondarily damaged, or an object at a further distance from the object that has come in contact with the attack object may be secondarily damaged).

The above program may cause the computer to further function as:

a firing character placement section that disposes a character that can fire the attack object in the virtual three-dimensional space, and

the search range setting section may change the size of the search range corresponding to the character that has fired the attack object that has come in contact with the object.

According to the above configuration, the size of the search range is changed corresponding to the character that has fired the attack object that has come in contact with the object. This makes it possible to express the difference in attack object firing power between the characters.

The above program may cause the computer to further function as:

a firing control section that fires the attack object from a given firing position, and

the search range setting section may change the size of the search range corresponding to the distance between the firing position and a contact position detected by the detection section.

According to the above configuration, the size of the search range is changed corresponding to the distance between the attack object firing position and the object contact position. This makes it possible to express a situation in which the power of the attack object (distance range in which the object is secondarily damaged) changes corresponding to the distance from the firing position (e.g., the size of the search range is increased when the distance between the firing position and the contact position is short so that a distant object can be secondarily damaged, or the size of the search range is decreased when the distance between the firing position and the contact position is long so that only a nearby object is secondarily damaged).

In the above program,

the selection section may search for a given number of objects that are positioned within the search range in the order from an object that is positioned closest to the object that has come in contact with the attack object.

According to the above configuration, a given number of objects that are positioned within the search range are searched in the order from the object that is positioned closest to the object that has come in contact with the attack object. Specifically, the objects are secondarily damaged in the order from the object that is positioned closest to the object that has come in contact with the attack object. Therefore, a natural effect in which a bullet (attack object) that has come in contact with the object and rebounded from the object preferentially damages the nearby object can be produced, for example.

In the above program,

the selection section may change the number of objects to be searched corresponding to the type of the attack object that has come in contact with the object.

According to the above configuration, the number of objects to be searched is changed corresponding to the type of the attack object that has come in contact with the object. Specifically, the number of objects to be secondarily damaged is changed corresponding to the type of the attack object that has come in contact with the object. Therefore, the difference in power corresponding to the type of the attack object can be expressed (e.g., only one object is damaged or a plurality of objects are damaged corresponding to the type of the attack object).

The above program may cause the computer to further function as:

a firing character arrangement section that disposes a plurality of characters that can fire the attack object in the virtual three-dimensional space, and

the search range setting section may change the number of objects to be selected corresponding to the character that has fired the attack object that has come in contact with the object.

According to the above configuration, the number of objects to be selected is changed corresponding to the character that has fired the attack object that has come in contact with the object. This makes it possible to express the difference in attack object firing power between the characters.

According to a further embodiment of the invention, there is provided a computer-readable information storage medium storing the above program. The term “information storage medium” used herein includes a magnetic disk, an optical disk, an IC memory, and the like.

Preferred embodiments of the invention are described below with reference to the drawings. The following description illustrates an example in which the invention is applied to an arcade game device that allows the player to play a first-person gun shooting game. Note that embodiments to which the invention may be applied are not limited thereto.

Configuration of Game Device

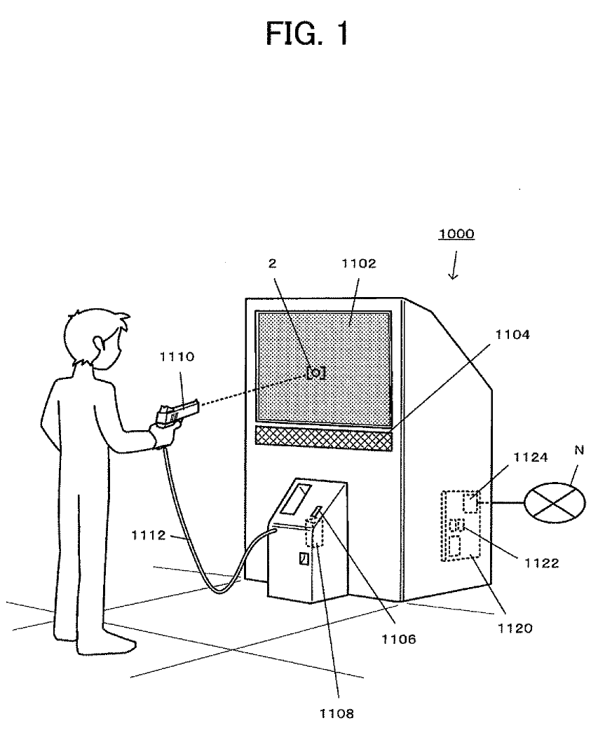

FIG. 1 is a view schematically showing an example of a game device 1000 according to one embodiment of the invention. The game device 1000 is an arcade game device that is installed in a game arcade, an amusement facility, or the like. The game device 1000 includes a display 1102 that is provided on the front side of a housing that is higher than the player to some extent and displays a game screen (image), a speaker 1104 that outputs a game sound, a coin insertion slot 1106 that receives a coin, a coin detection sensor 1108 that detects a coin inserted into the coin insertion slot 1106, and a gun-type controller 1110 that is connected to the housing through a cable 1112 and allows the player to input a game operation. The game device 1000 also includes a control unit 1120 that is provided in the housing.

The gun-type controller 1110 has a shape that imitates a gun such as a pistol or a rifle. The gun-type controller 1110 optically detects the sight position on the display 1102 using a lens and a photo sensor provided near the muzzle, and outputs the coordinates of the detected sight position to the control unit 1120. The gun-type controller 1110 includes a trigger. The gun-type controller 1110 detects whether or not the player has pulled the trigger, and outputs a trigger signal that indicates the detection result to the control unit 1120. The gun-type controller 1110 may have another configuration insofar as the gun-type controller 1110 can detect the sight position (i.e., the position indicated by the muzzle) on the display 1102 and output the trigger signal to the control unit 1120.

The control unit 1120 includes a microprocessor (e.g., central processing unit (CPU), graphics processing unit (GPU), and digital signal processor (DSP)), an application-specific integrated circuit (ASIC), an IC memory (e.g., VRAM, RAM, and flash memory 1122), a communication device 1124 that connects to a communication channel N, a driver circuit that drives the display 1102, an amplifier circuit that outputs a sound signal to the speaker 1104, and an interface circuit (I/F circuit) such as a signal input-output circuit that exchanges signals with the gun-type controller 1110 and the coin detection sensor 1108. The elements provided in the control unit 1120 are electrically connected through a bus circuit so that the elements can read/write data and transmit/receive a signal.

The flash memory 1122 stores a program and setting data necessary for the control unit 1120 to execute various game play-related calculations. When the coin detection sensor 1108 has detected that a given amount of coin has been inserted, the control unit 1120 reads a program and data from the flash memory 1122, and temporarily stores the program and data in the IC memory. The control unit 1120 then executes the program read from the flash memory 1122 to generate a game image and a game sound. The game image is displayed on the display 1102, and the game sound is output from the speaker 1104.

The player stands in front of the display 1102 (housing), and aims the gun-type controller 1110 at the display 1102. A sight 2 that indicates the position (sight position) at which the player aims using the gun-type controller 1110 is displayed in the game screen displayed on the display 1102. The player enjoys the shooting game by holding the gun-type controller 1110 so that the sight 2 coincides with an arbitrary target in the game screen, and pulling the trigger (shooting operation), for example.

Although this embodiment employs a configuration in which a necessary program and setting data are read from the flash memory 1122, it is also possible to employ a configuration in which the communication device 1124 connects to a cable/wireless communication channel N (e.g., Internet, local area network (LAN), or wide area network (WAN)), and downloads a necessary program and setting data from an external device.

Outline of Game

The game device 1000 according to this embodiment executes a first-person shooting game that allows the player to operate a player's character while watching a game screen as if to experience a game world from the viewpoint of the player's character (first person point of view), and attack an enemy character using a weapon such as a gun.

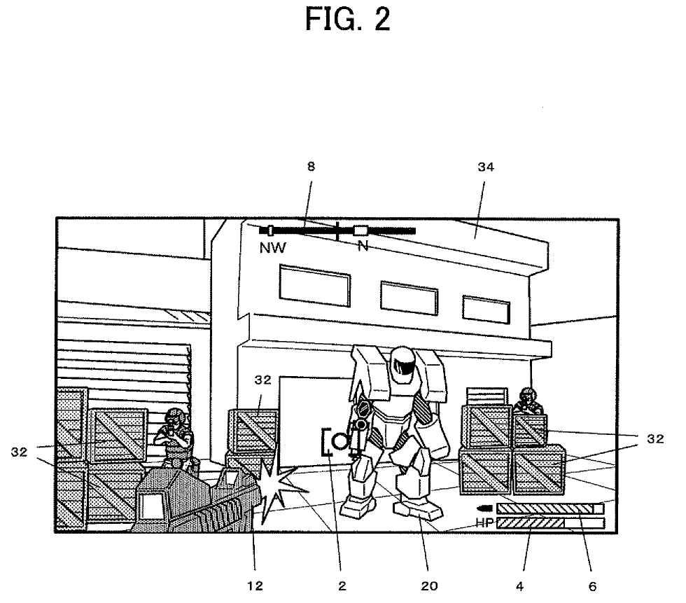

FIG. 2 is a view showing an example of a game screen according to this embodiment. In the game according to this embodiment, a game space (battlefield) is formed by disposing objects such as a ground, a floor, a wooden box 32, and a building 34 in a virtual three-dimensional space, and character objects such as a player's character 10 and an enemy character 20 (i.e., non-player character (NPC)) are disposed in the game space.

The emergence position and the operation of the enemy character 20 are determined in advance. The operation of the enemy character 20 is automatically controlled so that the enemy character 20 approaches and attacks the player's character 10 at a given timing.

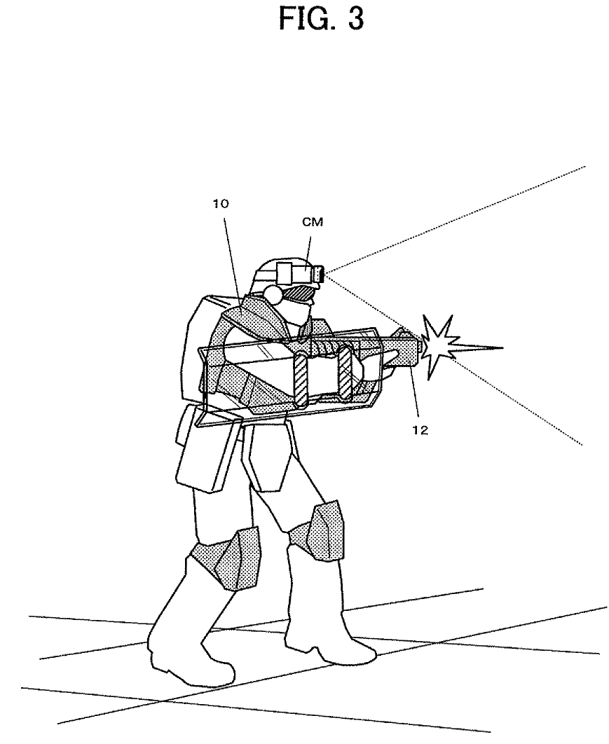

The movement and the line-of-sight direction of the player's character 10 are automatically controlled so that the player's character 10 moves within the game space along a given path and gazes at the enemy character 20 at a given attack point (position). As shown in FIG. 3, a virtual camera CM is set corresponding to the player's character 10 so that the virtual camera CM coincides with the viewpoint of the player's character 10. A game space image (i.e., an image of the game space viewed from the virtual camera CM) is generated as a three-dimensional CG image. A game screen is generated by synthesizing the game space image with various information indicators such as a hit point gauge 4 that indicates the hit point (strength value) of the player's character 10, a bullet gauge 6 that indicates the number of bullets loaded to the gun 12, a direction indicator 8 that indicates the line-of-sight direction, and the sight 2 that indicates the position indicated by the gun-type controller 1110. The game screen thus generated is displayed on the display 1102. Specifically, a first-person game screen is generated and displayed.

The player adjusts the shooting direction by changing the direction of the muzzle of the gun-type controller 1110 so that the sight 2 coincides with the enemy character 20 displayed in the game screen, and then pulls the trigger (shooting operation) so that a bullet is fired from the gun 12 held by the player's character 10 and hits the enemy character 20.

In this embodiment, the hit point of the player's character 10 is decremented when the enemy character 20 has attacked the player's character 10 in the same manner as in a known gun shooting game. The player clears the game when the player's character 10 has reached a given goal point before the hit point reaches “0”, otherwise the game ends (game over).

Bullet Rebound Principle

When a bullet (i.e., attack object) fired from the gun 12 held by the player's character 10 has hit (come in contact with) the enemy character 20 by the shooting operation performed by the player, the enemy character 20 is damaged. The player can defeat the enemy character 20 when the enemy character 20 has been damaged to a given level. Specifically, the hit point of the enemy character 20 is decremented corresponding to the damage to the enemy character 20. The player can defeat the enemy character 20 when the hit point has reached “0”. Specifically, points decremented from the initial hit point correspond to the damage level, and the allowable damage level corresponds to the initial hit point.

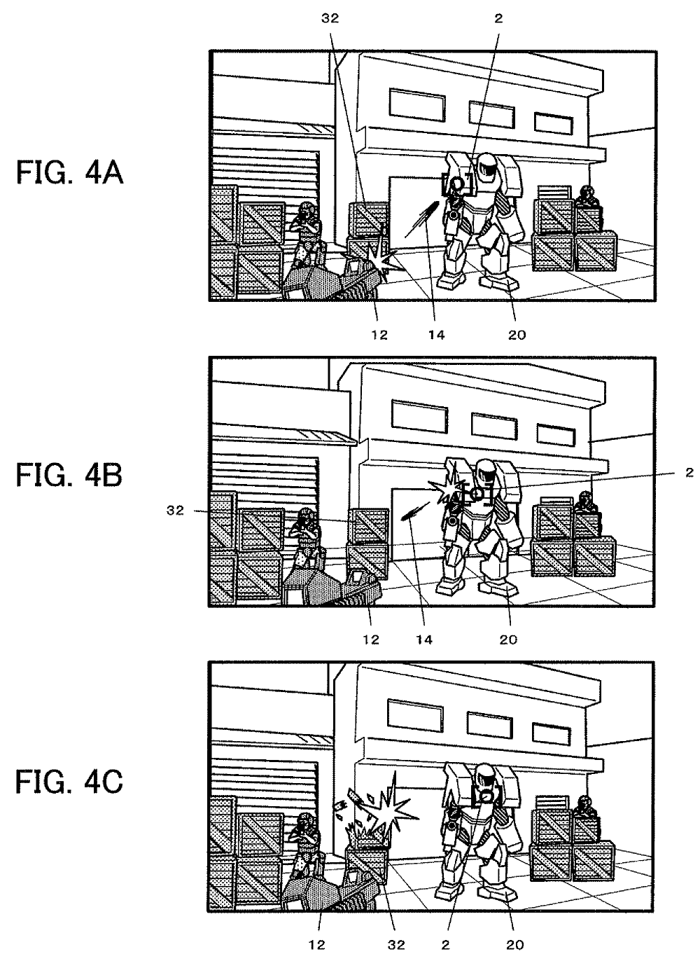

In this embodiment, when a bullet has hit the enemy character 20, the bullet rebounds from the enemy character 20 and hits another object positioned near the enemy character 20 (i.e., bullet rebound). FIGS. 4A to 4C are views showing examples of a game screen in which a bullet rebounds. As shown in FIG. 4A, when the player has pulled the trigger of the gun-type controller 1110 in a state in which the sight 2 coincides with the enemy character 20, a bullet 14 is fired from the gun 12 held by the player's character 10, and travels (flies) toward the enemy character 20. When the bullet 14 has hit the enemy character 20, the enemy character 20 is damaged due to the bullet 14 that has hit the enemy character 20. The bullet 14 that has hit the enemy character 20 rebounds from the enemy character 20 (see FIG. 4B), and hits a wooden box 32 (i.e., another object positioned near the enemy character 20) so that the wooden box 32 breaks (see FIG. 4C). In FIGS. 4A to 4C, a state in which the bullet 14 flies is displayed in the game screen. Note that a state in which the bullet 14 flies may not be displayed since the bullet 14 flies at high speed. As an effect (hit effect) produced when the bullet 14 has hit the object, a breaking sound corresponding to the type of the object hit by the bullet 14 may be output, or the gun-type controller 1110 may vibrate in addition to displaying a state in which the object breaks.

An object (hereinafter referred to as “rebound bullet target object”) that is damaged by the rebound bullet 14 is limited to a breakable object determined in advance. Specifically, the rebound bullet does not necessarily hit all of the objects that form the game space. For example, the rebound bullet does not hit an object (unbreakable object) that changes the structure of the game stage when it breaks (e.g., the ground or the floor on which the character moves). An object (e.g., wooden box 32 or building 34) other than the unbreakable object falls under the category of breakable object. The character (e.g., player's character 10 or enemy character 20) is also excluded from the rebound bullet target. Specifically, the bullet rebound effect according to this embodiment is an effect that allows the player to fully enjoy the gun shooting game in which a plurality of objects sequentially break by a single shooting operation. Note that the breakable object is also damaged and breaks when directly hit by the bullet 14 fired from the gun 12.

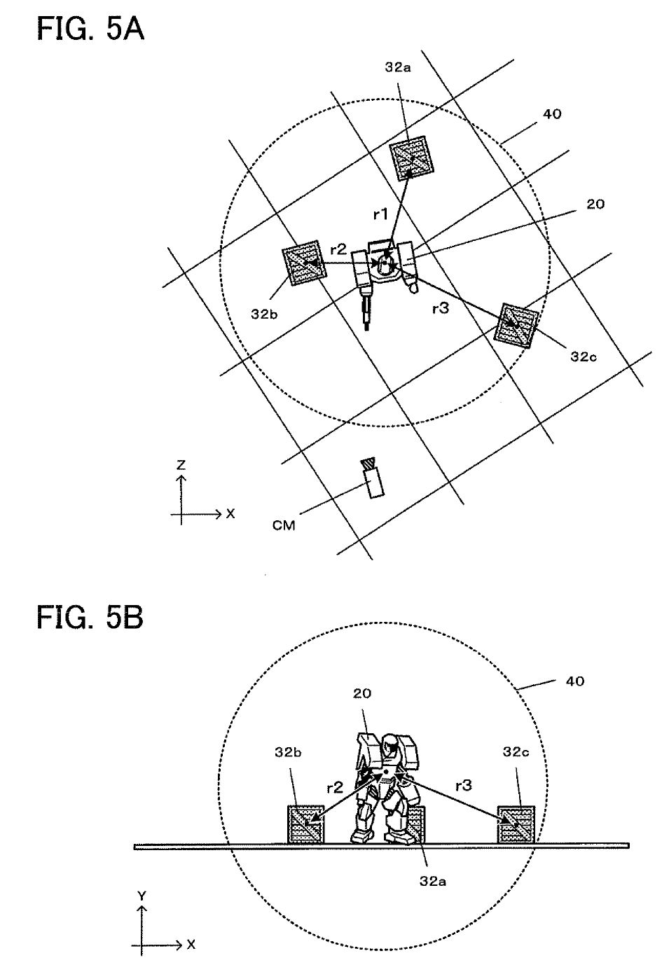

The rebound bullet target object is determined as follows. As shown in FIGS. 5A and 5B, a rebound bullet target range 40 is set around the position of the enemy character 20 that has been hit by the bullet 14. FIG. 5A is a top view showing the game space, and FIG. 5B is a side view showing the game space. As shown in FIGS. 5A and 5B, a spherical rebound bullet target range 40 is set around the position (representative point) of the enemy character 20 that has been hit by the bullet 14. The radius R of the spherical rebound bullet target range 40 is determined based on the type of the gun 12 held by the player's character 10.

The object that is positioned closest to the enemy character 20 among the breakable objects positioned within the rebound bullet target range 40 is determined to be the rebound bullet target object. In FIGS. 5A and 5B, three wooden boxes 32a to 32c (breakable objects) are positioned within the rebound bullet target range 40. The distances r1 to r3 from the enemy character 20 to the wooden boxes 32a to 32c have the relationship “r2<r1<r3”. In this case, the wooden box 32b is determined to be the rebound bullet target object.

A hit effect that indicates that the rebound bullet target object has been damaged by the rebound bullet is then produced. For example, a flash, smoke, and scattering fragments that show that the bullet 14 has hit the wooden box 32 (rebound bullet target object) are displayed (see FIG. 4C), and the rebound bullet target object is replaced by a replacement model that shows the rebound bullet target object that has partially or completely broken.

The breakable object is formed by one or more parts. Whether or not the bullet has hit the breakable object is determined corresponding to each part that forms the breakable object, and the part that has been determined to be hit is damaged. Specifically, one of the parts that form the breakable object is damaged when the bullet has hit the breakable object.

For example, a relatively small breakable object (e.g., wooden box 32) is formed by one part, and a relatively large breakable object (e.g., building 34) is formed by a plurality of parts since such a relatively large breakable object normally does not easily break. Each part is formed by dividing each member that forms the breakable object to have appropriate dimensions (e.g., 50×50 cm) so that each part breaks when hit by a single bullet.

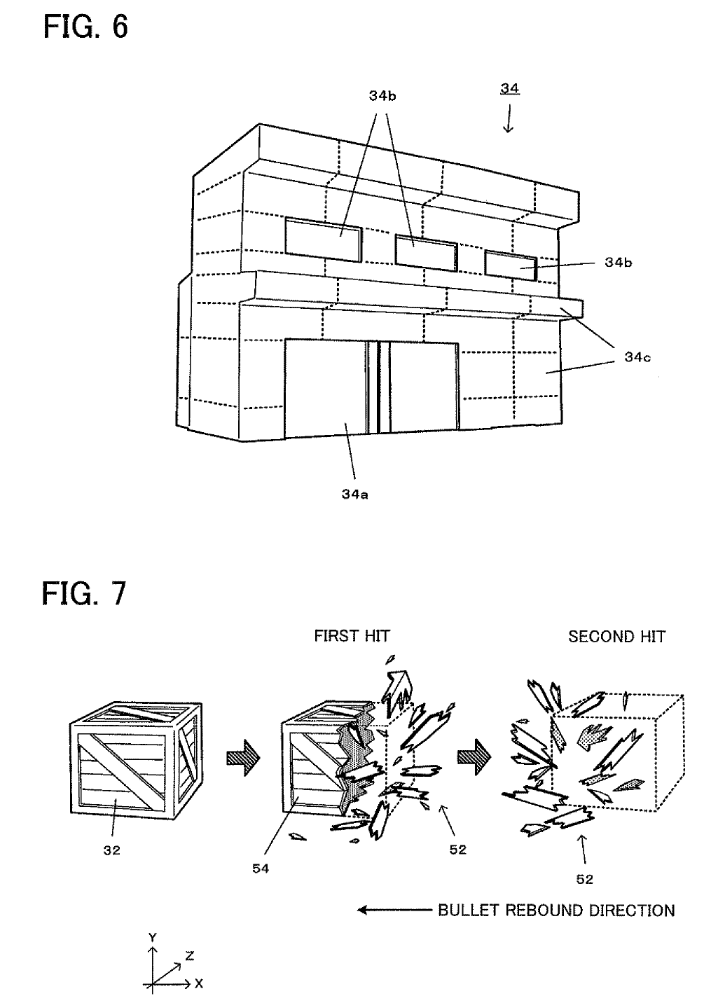

FIG. 6 is a view showing examples of parts that form the building 34. The building 34 shown in FIG. 6 is mainly formed by three members (i.e., entrance 34a, window 34b, and wall 34c). The window 34b is formed by one part, and the entrance 34a is formed by two parts (doors). The wall 34c is divided into a plurality of parts having appropriate dimensions (see dotted lines).

The rebound bullet target is determined corresponding to each part that forms the breakable object. Specifically, the rebound bullet target part is the part that is positioned closest to the enemy character 20 hit by the bullet 14 among the parts that form the breakable objects disposed in the game space and are positioned within the rebound bullet target range 40.

The parts that form the breakable object are classified into a part that completely breaks when hit by a single bullet, and a part that does not completely break when hit by a single bullet. Specifically, an allowable hit count (allowable damage level) required for complete breakage is defined corresponding to each part. Complete breakage occurs when the hit count (allowable remaining damage level) has reached the allowable hit count. The allowable hit count indicates the resistance to bullets. The allowable hit count is determined corresponding to the type and the material of each part. Note that a part that has completely broken is deleted from the game space.

Specifically, a part for which the allowable hit count is “1” completely breaks when hit by a single bullet. In this case, a situation (effect) in which fragments of the part scatter is displayed, and the part is deleted from the game space. On the other hand, a part for which the allowable hit count is two or more completely breaks when the hit count has reached the allowable hit count. In this case, a situation (effect) in which fragments of the part scatter is displayed each time a bullet hits the part, and the part is replaced by a replacement model that shows the corresponding part that is partially broken. When the hit count has reached the allowable hit count, a situation (effect) in which fragments scatter is similarly displayed, and the replacement model is deleted from the game space.

For example, the allowable hit count of the wooden box 32 shown in FIG. 7 is “2”. In this case, when the wooden box 32 has been hit initially, an effect 52 that shows a state in which fragments of the wooden box 32 scatter is displayed, and the wooden box 32 is replaced by a replacement model 54 (i.e., half of the wooden box 32 has broken). When the wooden box 32 has been hit again, the effect 52 that shows a state in which fragments of the wooden box 32 scatter is displayed, and the replacement model 54 is deleted (i.e., the wooden box 32 has completely broken).

In order to display a situation in which the rebound bullet target object breaks from the hit side, the replacement model 54 is disposed so that the broken area faces the bullet rebound direction. The bullet rebound direction is a direction from the enemy character 20 hit by the bullet to the rebound bullet target part.

For example, when the wooden box 32 shown in FIG. 7 has been hit initially, the wooden box 32 is replaced by the replacement model 54 that shows a state in which half of the wooden box 32 has broken. The bullet rebound direction is a direction (negative X-axis direction) from the right to the left in FIG. 7. Therefore, the replacement model 54 is disposed so that the broken area is positioned on the right so that a state in which the right half of the wooden box 32 has been broken by the rebound bullet that travels from the right is displayed.

Functional Configuration

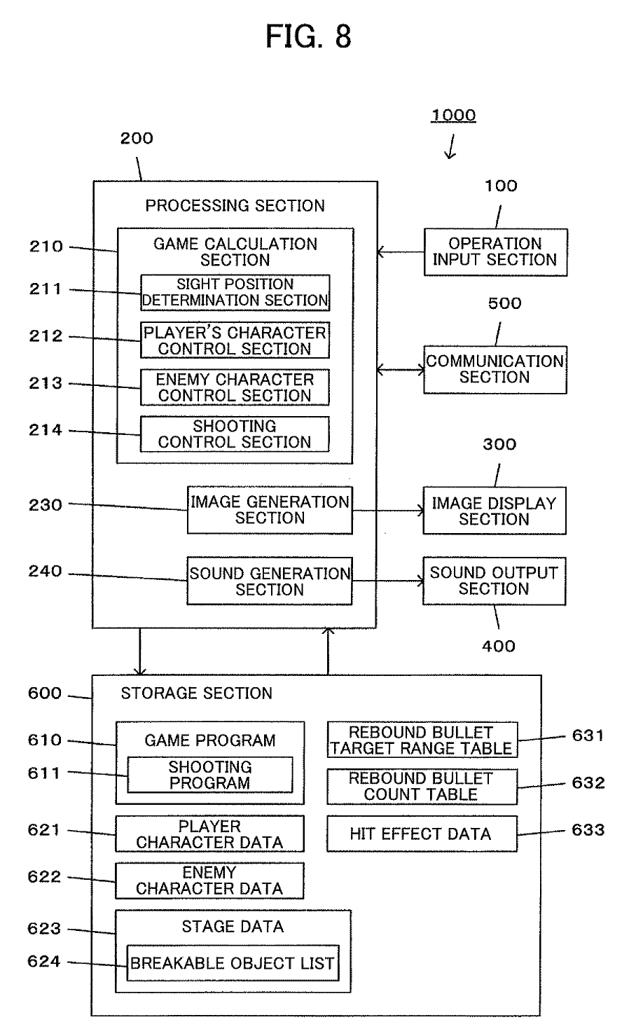

FIG. 8 is a block diagram showing the functional configuration of the game device 1000. As shown in FIG. 8, the game device 1000 includes an operation input section 100, a processing section 200, an image display section 300, a sound output section 400, a communication section 500, and a storage section 600.

The operation input section 100 receives an operation input by the player, and outputs an operation signal corresponding to the operation to the processing section 200. The function of the operation input section 100 is implemented by a button switch, a joystick, a touch pad, a trackball, a multi-axis acceleration sensor that has two or more detection axes, a single-direction tilt sensor unit having different detection axes, a video camera that photographs a deviation from a reference position, and the like. In FIG. 1, the gun-type controller 1110 corresponds to the operation input section 100.

The processing section 200 controls the entire game device 1000 and executes various calculations (e.g., game process and image generation process) based on a program and data read from the storage section 600, the operation signal input from the operation input section 100, and the like. The function of the processing section 200 is implemented by a microprocessor (e.g., CPU and GPU), an application-specific integrated circuit (ASIC), an IC memory, and the like. In FIG. 1, the control unit 1120 corresponds to the processing section 200. The processing section 200 includes a game calculation section 210, an image generation section 230, and a sound generation section 240.

The game calculation section 210 executes a game process. For example, the game calculation section 210 disposes an object (e.g., ground, floor, or building) in the virtual three-dimensional space to form a game space, disposes the player's character 10 and the enemy character 20 in the game space, controls the movement and the attack operation of the character, determines whether or not an object has hit another object due to attack or the like (whether or not a bullet has hit a character), performs physical calculations, and calculates the game result. In this embodiment, the game calculation section 210 includes a sight position determination section 211, a player's character control section 212, an enemy character control section 213, and a shooting control section 214.

The sight position determination section 211 determines the coordinates of the sight position indicated by the operation input section 100 in the game screen coordinate system. Specifically, the sight position determination section 211 calculates the position on the screen indicated by the muzzle of the gun-type controller 1110 aimed at the display 1102. The sight position determination section 211 calculates the sight position in the virtual three-dimensional space from the position on the screen indicated by the muzzle of the gun-type controller 1110, and determines the sight position to be the position at which the player's character 10 aims the muzzle of the gun 12. The function of the sight position determination section 211 may be implemented by utilizing known gun shooting game device technology.

The player's character control section 212 controls the operation of the player's character 10. Specifically, the player's character control section 212 controls the movement of the player's character 10 so that the player's character 10 moves along a given path at a given timing, and controls the line-of-sight direction of the player's character 10 so that the player's character 10 that moves along a given path gazes at the enemy character 20 at a given timing. When the player has performed a shooting operation, the player's character control section 212 controls the operation of the player's character 10 so that the player's character 10 fires the gun 12 at the sight position calculated by the sight position determination section 211. In this embodiment, the movement of the player's character 10 is set so that the player's character 10 moves along a given path. When employing a configuration that allows the player to arbitrarily move the player's character 10, the player's character control section 212 also moves the player's character 10 based on a movement operation input.

The enemy character control section 213 automatically controls the operation (e.g., appearance, movement, attack, and escape) of the enemy character 20. The enemy character control section 213 may have an AI control function that automatically determines the operation of the enemy character 20 according to a given thinking routine.

The shooting control section 214 determines whether or not the object has been hit (shooting operation result) when the player has performed a shooting operation. Specifically, the shooting control section 214 determines whether or not the bullet 14 fired from the gun 12 held by the player's character 10 has hit each object disposed in the virtual three-dimensional space based on the sight position in the virtual three-dimensional space calculated by the sight position determination section 211 when the player has performed a shooting operation, and determines the object that has been hit by the bullet 14.

Data that indicates the current position of the player's character 10 and data that indicates the current position of the enemy character 20 are stored as player's character data 621 and enemy character data 622, respectively. The player's character data 621 and the enemy character data 622 also include model data, texture data, motion data, and data that indicates the capability value (e.g., attack capability), the thinking routine, the hit point, and the like.

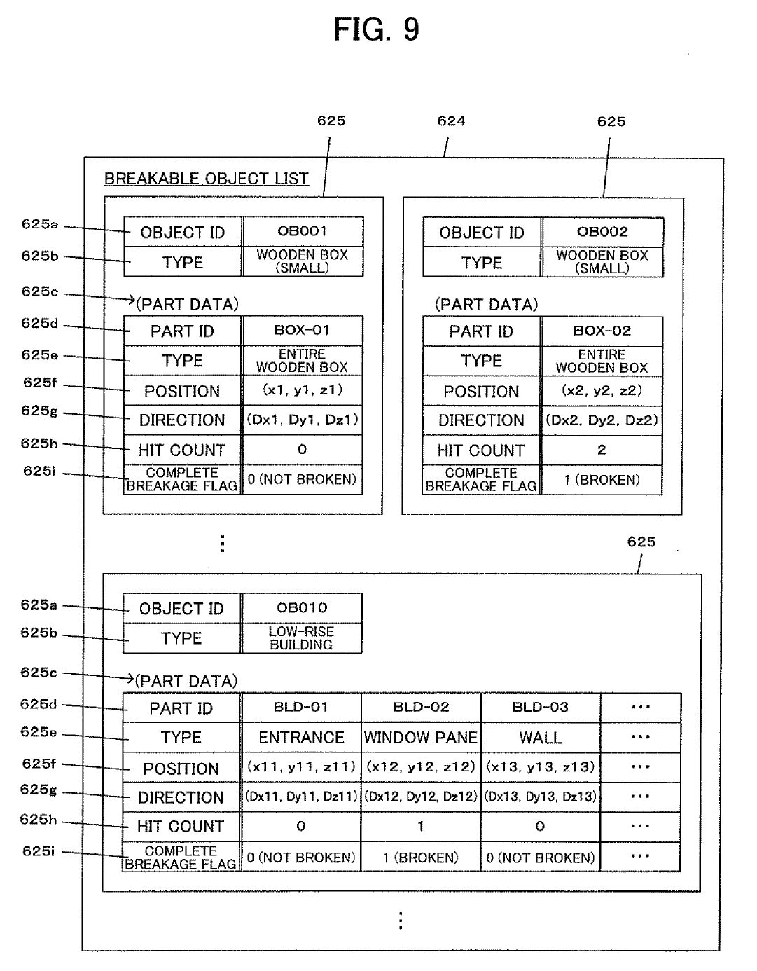

A breakable object list 624 stores data that indicates the position of the breakable object that forms the game space. FIG. 9 is a view showing an example of the data configuration of the breakable object list 624. As shown in FIG. 9, the breakable object list 624 includes breakable object data 625 corresponding to each breakable object that forms the game space. An object ID 625a and a type 625b of the corresponding breakable object, and part data 625c (that indicates each part that forms the breakable object) are stored as the breakable object data 625. A part ID 625d, a type 625e, a position 625f (in the game space), a direction 625g, a hit count 625h, and a complete breakage flag 625i are stored as the part data 625c corresponding to each part that forms the breakable object. The hit count 625h indicates the total hit count of the rebound hit count and the direct hit count. When the hit count 625h has reached the allowable hit count, the corresponding part has completely broken. The complete breakage flag 625i is a flag that indicates whether or not the corresponding part has completely broken. When the complete breakage flag 625i is “1” (complete breakage), the corresponding part has been deleted from the game space.

When the shooting control section 214 has determined that the fired bullet has hit the enemy character 20, the enemy character 20 is damaged. For example, the hit point of the enemy character is decremented corresponding to the damage to the enemy character 20. Specifically, the damage to the enemy character 20 (i.e., points subtracted from the hit point) is determined corresponding to the type of the bullet (i.e., the type of the weapon 12) that has hit the enemy character 20. Alternatively, the damage to the enemy character 20 may be determined corresponding to the combination of the type of the player's character 10 and the type of the weapon 12.

The shooting control section 214 also performs a bullet rebound process. Specifically, the shooting control section 214 determines a rebound bullet count N (i.e., the number of rebound bullets) according to a rebound bullet count table 632.

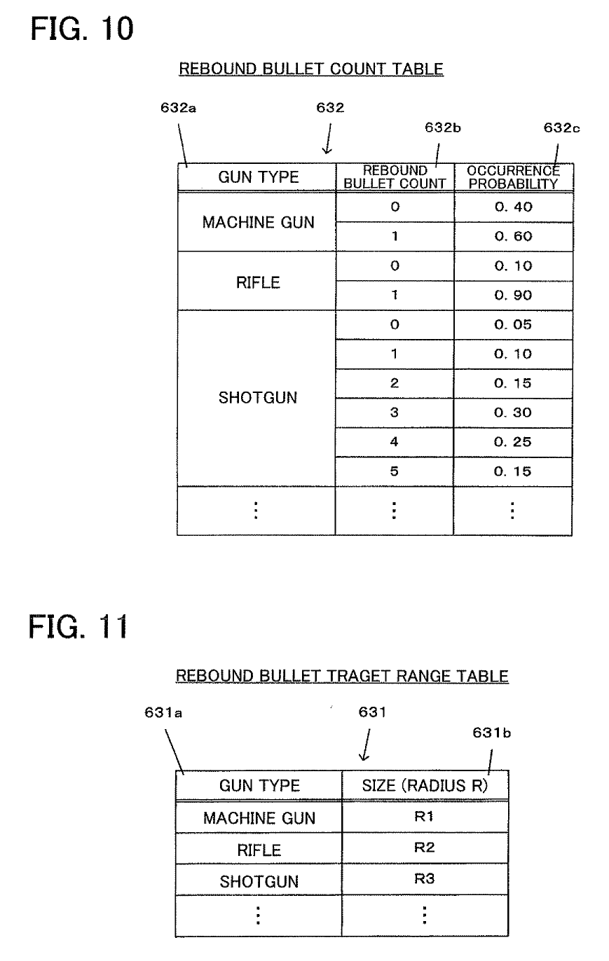

FIG. 10 shows an example of the data configuration of the rebound bullet count table 632. As shown in FIG. 10, the rebound bullet count table 632 stores a rebound bullet count 632b and an occurrence probability 632c corresponding to a gun type 632a (i.e., the type of gun that may be used by the player's character 10).

The rebound bullet count 632b indicates the number of rebound bullets that may occur due to a single shooting operation. When the weapon is a machine gun or a rifle, one bullet is fired when the player has performed a shooting operation. Therefore, the rebound bullet count is “0” or “1”. On the other hand, when the weapon is a shotgun, a number of pellets scatter when the player has performed a shooting operation. Therefore, the maximum rebound bullet count is two or more (“0” to “5” in FIG. 10). The occurrence probability 632c indicates the probability that the bullet rebounds corresponding to the rebound bullet count 632b. The sum of the occurrence probabilities corresponding to each gun type is “1.0”.

Specifically, the rebound bullet count N is determined based on the occurrence probability that is set corresponding to the current gun type of the player's character 10. When the rebound bullet count N is “1” (i.e., a rebound occurs), a bullet rebound effect is displayed. When the rebound bullet count N is “0” (i.e., a rebound does not occur), a bullet rebound effect is not displayed. When displaying a bullet rebound effect, the rebound bullet target range 40 is set around the position (representative point) of the enemy character 20 that has been hit by the bullet 14 according to a rebound bullet target range table 631.

FIG. 11 shows an example of the data configuration of the rebound bullet target range table 631. As shown in FIG. 11, the rebound bullet target range table 631 stores a gun type 631a and a size 631b of the rebound bullet target range 40. The radius R of the spherical rebound bullet target range is stored as the size 631b. The size 631b is determined based on the shooting capability of the corresponding gun.

Specifically, a spherical range that is formed around the position of the enemy character 20 that has been hit by the bullet 14 and has a radius R corresponding to the type of the gun 12 is set as the rebound bullet target range 40.

The rebound bullet target part is then determined. Specifically, a part (i.e., rebound bullet target part) that is positioned closest to the enemy character 20 is selected corresponding to the rebound bullet count N from the parts that form the breakable objects disposed in the game space and are positioned within the rebound bullet target range 40. Specifically, N rebound bullet target parts are selected.

A hit effect is then produced corresponding to each rebound bullet target part according to hit effect data 633.

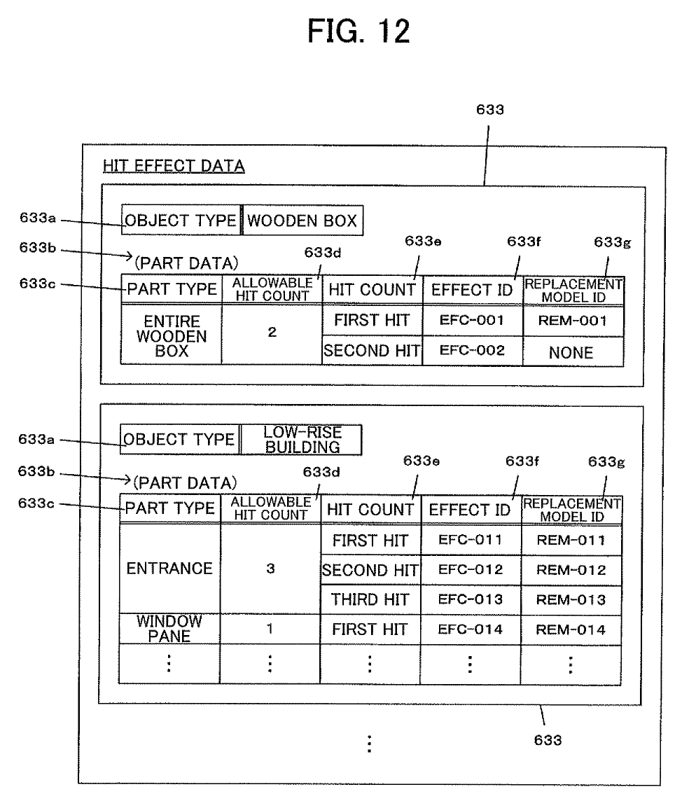

FIG. 12 shows an example of the data configuration of the hit effect data 633. As shown in FIG. 12, the hit effect data 633 is generated corresponding to the type of breakable object. A type 633a of the corresponding object and part data 633b corresponding to each part that forms the object are stored as the hit effect data 633. An allowable hit count 633d, a hit count 633e, an effect ID 633f, and a replacement model ID 633g are stored as the part data 633b corresponding to each part type 633c.

Specifically, the hit effect is produced corresponding to each rebound bullet target part according to the hit effect data 633 corresponding to the type of the breakable object that includes the rebound bullet target part. Specifically, the effect 52 corresponding to the type of the part and the latest hit count is generated near the hit target part, and the part is replaced by the corresponding replacement model 54. The replacement model 54 is disposed so that the broken area faces the bullet rebound direction. The bullet rebound direction is the direction from the enemy character 20 hit by the bullet to the rebound bullet target part. When the replacement model 54 corresponding to the hit count is not defined as the hit effect data 633, the object (the rebound bullet target part or the replacement model 54) that is currently disposed is deleted from the virtual three-dimensional space.

As the hit effect, a breaking sound may be output, or a vibration section provided in the operation input section may be caused to vibrate in addition to displaying the effect 52 and replacing the object by the replacement model 54. Specifically, when outputting a breaking sound, sound data of the breaking sound corresponding to the part type and the hit count (that indicates the degree of breakage) is stored as the hit effect data 633 corresponding to each combination of the part type and the hit count. For example, sound data of a wooden board breaking sound for which the loudness and the duration differ corresponding to the hit count is stored corresponding to the part type “entire wooden box”. Sound data of a glass breaking sound is stored corresponding to the part “window pane”. When causing the vibration section to vibrate, a vibration pattern corresponding to the part type and the hit count is stored as the hit effect data 633 corresponding to each combination of the part type and the hit count.

When the shooting control section 214 has determined that the fired bullet has hit the breakable object, the hit effect is produced corresponding to the breakable object in the same manner as in the case where a rebound bullet has hit the breakable object. Specifically, the part that has been hit by the bullet is determined to be the hit target part from the parts that form the breakable object. The hit effect is then produced corresponding to the hit target part according to the hit effect data 633 corresponding to the type of the breakable object that has been hit. Specifically, the effect 52 corresponding to the type of the part and the latest hit count is generated near the hit target part, and the part is replaced by the corresponding replacement model 54.

Again referring to FIG. 8, the image generation section 230 is implemented by a processor (e.g., graphics processing unit (GPU) or a digital signal processor (DSP)), a video signal IC, a program (e.g., video codec), a drawing frame IC memory (e.g., frame buffer), and the like. The image generation section 230 generates one game image within one frame time ( 1/60th of a second) based on the processing results of the game calculation section 210, and outputs an image signal of the generated game image to the image display section 300.

The image display section 300 displays a game screen based on the image signal input from the image generation section 230 while redrawing the image of one frame every 1/60th of a second, for example. The function of the image display section 330 is implemented by a display device such as a CRT, an LCD, an ELD, or a PDP. In FIG. 1, the display 1102 corresponds to the image display section 300.

The sound generation section 240 is implemented by a processor (e.g., digital signal processor (DSP) or sound synthesis IC) and an audio codec that can reproduce a sound file, for example. The sound generation section 240 generates a sound signal of a game-related effect sound, background music (BGM), or an operation sound based on the processing results of the game calculation section 210, and outputs the generated sound signal to the sound output section 400.

The sound output section 400 outputs a game sound such as BGM and an effect sound based on the sound signal input from the sound generation section 240. The function of the sound output section 400 is implemented by a sound output device such as a speaker. In FIG. 1, the speaker 1104 corresponds to the sound output section 400.

The communication section 500 connects to the communication channel N to implement communication. The function of the communication section 500 is implemented by a transceiver, a modem, a terminal adapter (TA), a jack for a communication cable, a control circuit, or the like. In FIG. 1, the communication device 1124 corresponds to the communication section 500.

The storage section 600 stores a system program that implements a function of causing the processing section 200 to control the game device 1000, a game program and data necessary for causing the processing section 200 to execute the game, various types of data, and the like. The storage section 600 is used as a work area for the processing section 200, and temporarily stores the results of calculations performed by the processing section 200 based on a program, data input from the operation section 100, and the like. The function of the storage section 600 is implemented by an IC memory (e.g., RAM or ROM), a magnetic disk (e.g., hard disk), an optical disk (e.g., CD-ROM or DVD), or the like. In FIG. 1, the flash memory 1122 included in the control unit 1120 or the like corresponds to the storage section 600. In this embodiment, the storage section 600 stores a game program 610 including a shooting program 611, the player's character data 621, the enemy character data 622, stage data 623 including the breakable object list 624, the rebound bullet target range table 631, the rebound bullet count table 632, and the hit effect data 633.

The stage data 623 is data for forming the game space in the virtual three-dimensional space. The stage data 623 includes model data of the ground and the floor on which the player's character 10 and the enemy character 20 move, model data and texture data of various objects disposed on the ground or floor, position data, posture data, and the like corresponding to each game stage.

Process Flow

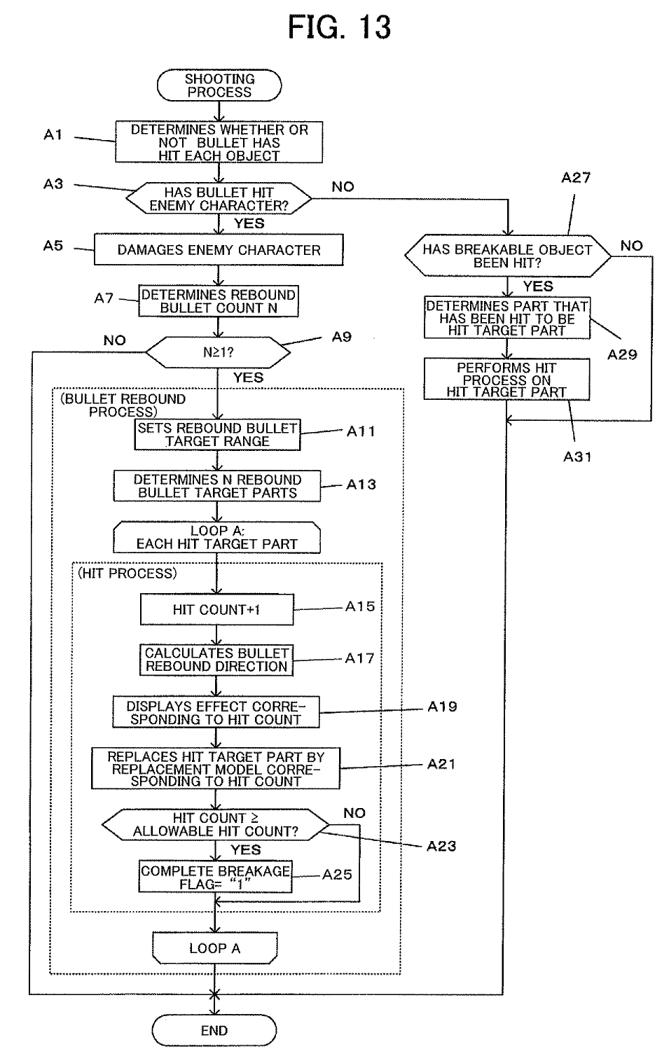

FIG. 13 is a flowchart illustrative of the flow of a shooting process. The shooting process is executed according to the shooting program 611 included in the game program 610 each time the player performs a shooting operation when the gun shooting game is executed according to the game program 610.

As shown in FIG. 13, the shooting control section 214 determines whether or not a bullet fired by the shooting operation has hit each object disposed in the virtual three-dimensional space, and determines the object hit by the bullet (step A1). When the shooting control section 214 has determined that the bullet has hit the enemy character 20 (step A3: YES), the shooting control section 214 performs a given damaging process (e.g., decrements the hit point corresponding to the type of the bullet (i.e., the type of the weapon 12) that has hit the enemy character 20) on the enemy character 20 (step A5). The shooting control section 214 also determines the rebound bullet count N according to the rebound bullet count table 632 (step A7).

When the shooting control section 214 has determined that the rebound bullet count N is equal to or larger than “1” (step A9: YES), the shooting control section 214 performs a bullet rebound process that causes the bullet to rebound from the enemy character 20. Specifically, the shooting control section 214 sets the rebound bullet target range 40 around the position of the enemy character 20 that has been hit by the bullet 14 according to the rebound bullet target range table 631 (step A11). The shooting control section 214 refers to the breakable object list 624, and selects the part that is positioned closest to the enemy character 20 as the hit target part from the parts that form the breakable object and are positioned within the rebound bullet target range 40 corresponding to the rebound bullet count N (step A13).

The shooting control section 214 then performs a hit process on each hit target part (loop A). Specifically, the shooting control section 214 adds “1” to the hit count of the hit target part (step A15). The shooting control section 214 sets the direction from the enemy character 20 that has been hit by the bullet 14 to the rebound bullet target part to be the bullet rebound direction (step A17) The shooting control section 214 then displays the effect 52 corresponding to the type of the part and the updated hit count near the hit target part (step A19), and replaces the hit target part by the corresponding replacement model 54 while taking account of the bullet rebound direction (step A21) according to the hit effect data 633 corresponding to the type of the breakable object that includes the hit target part as an element. In this case, the shooting control section 214 may output a breaking sound or cause the vibration section to vibrate corresponding to the type of the part and the hit count. When the hit count has reached the allowable hit count defined corresponding to the type of the hit target part (i.e., the hit target part has completely broken) (step A23; YES), the shooting control section 214 sets the complete breakage flag to “1” (step A25). The hit process is thus completed.

When the shooting control section 214 has determined that the fired bullet has directly hit the breakable object (step A3: NO to A27: YES), the shooting control section 214 determines the part that has been hit by the bullet (i.e., hit target part) from the parts that form the breakable object (step A29). The shooting control section 214 then performs the hit process (steps A15 to A25) on the hit target part (step A31). The shooting process is thus completed.

Effects

According to this embodiment, when the player has performed a shooting operation by operating the gun-type controller 1110 during the first-person gun shooting game, the bullet 14 is fired from the gun 12 held by the player's character 10. When the bullet 14 fired from the gun 12 has hit the enemy character 20, the enemy character 20 that has been hit by the bullet 14 is damaged, and the bullet 14 rebounds from the enemy character 20 and hits another object (e.g., wooden box 32) positioned near the enemy character 20 so that the other object breaks. Therefore, an attractive effect in which another object (e.g., wooden box 32) positioned near the enemy character 20 is damaged by the rebound bullet in addition to the shooting target object (enemy character 20) is produced. This implements a more interesting shooting game.

Modification

Embodiments to which the invention may be applied are not limited to the above embodiments. Various modifications and variations may be made without departing from the scope of the invention.

(A) Rebound Bullet Count N

The above embodiments have been described taking an example in which the rebound bullet count N is determined by probability calculations. Note that the rebound bullet count N may be determined corresponding to the type of the gun 12 or the type of the player's character 10. For example, a plurality of characters such as an armed soldier, a private soldier, a commander, and an apprentice soldier are provided as the player's characters 10, and a character selected by the player before the game starts is used as the player's character 10.

(B) Rebound Bullet Target Range 40

The rebound bullet target range 40 may be set as described below.

(B-1) Shape and Direction

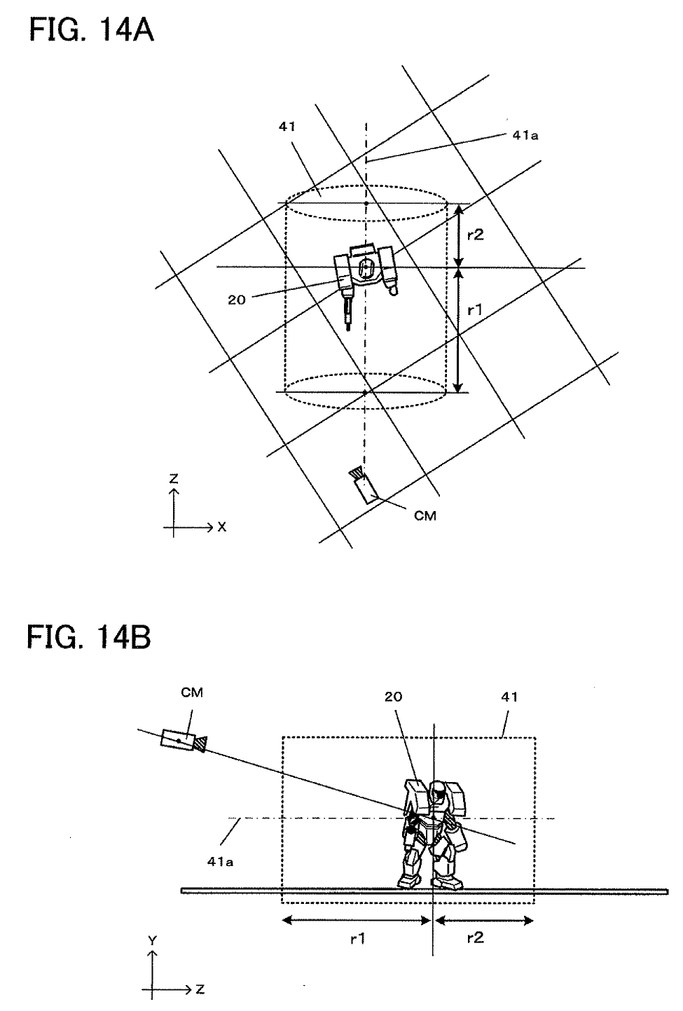

The rebound bullet target range 40 may have a shape other than a spherical shape. For example, the rebound bullet target range 40 may have a cylindrical shape, and may be disposed along the line-of-sight direction of the virtual camera. FIGS. 14A and 14B show an example of a cylindrical rebound bullet target range. FIG. 14A is a top view showing the game space, and FIG. 14B is a side view showing the game space. A rebound bullet target range 41 having a cylindrical shape is disposed so that a center axis 41a horizontally passes through the position (representative point) of the enemy character 20 that has been hit by a bullet. When viewed from above, the center axis 41a coincides with a straight line that connects the position of the virtual camera CM that coincides with the viewpoint of the player's character 10 and the position of the enemy character 20. Since an image viewed from the virtual camera CM is displayed as the game screen, an attractive bullet rebound process is produced in the game screen by disposing the cylindrical rebound bullet target range 41 along the line-of-sight direction of the virtual camera CM. Moreover, since the bullet rebound process is not produced outside the game screen, a reasonable effect can be implemented.

The rebound bullet target range 41 is set so that the distance r1 between the front side of the cylindrical shape and the position of the enemy character 20 is longer than the distance r2 between the position of the enemy character 20 and the rear side of the cylindrical shape. When a bullet rebounds behind the enemy character 20 when viewed from the virtual camera CM, an effect displayed in the game screen is small. Therefore, a wide rebound bullet target range is provided near the virtual camera CM as compared with the enemy character 20.

Note that the shape of the rebound bullet target range 40 is not limited to a cylindrical shape. For example, the rebound bullet target range 40 may have another tubular shape (e.g., quadrangular prism), or may be a cone or a pyramid having a vertex on the side of the virtual camera CM. When the rebound bullet target range 40 has a shape with directionality (e.g., tubular or conical shape), it is effective to determine the direction of the rebound bullet target range 40 corresponding to the relative positional relationship between the virtual camera CM and the enemy character 20 that has been hit by a bullet. In the example shown in FIG. 14, the cylindrical rebound bullet target range 41 is horizontally disposed along the line-of-sight direction of the virtual camera CM. Note that the cylindrical rebound bullet target range 41 may be disposed along a straight line that connects the position of the virtual camera CM and the position of the enemy character 20 (i.e., the rebound bullet target range 40 is set diagonally in FIG. 14B since the center axis 41a inclines).

(B-2) Change in Rebound Bullet Target Range 40 Corresponding to Part of Enemy Character 20 Hit by Bullet

The shape, size, and direction of the rebound bullet target range 40 may be changed corresponding to the part of the enemy character 20 that has been hit by the bullet 14. Specifically, the enemy character 20 is divided into a plurality of parts, and a rebound bullet target range is set corresponding to each part. The range corresponding to the part (hit part) that has been hit by the bullet is set to be the rebound bullet target range.

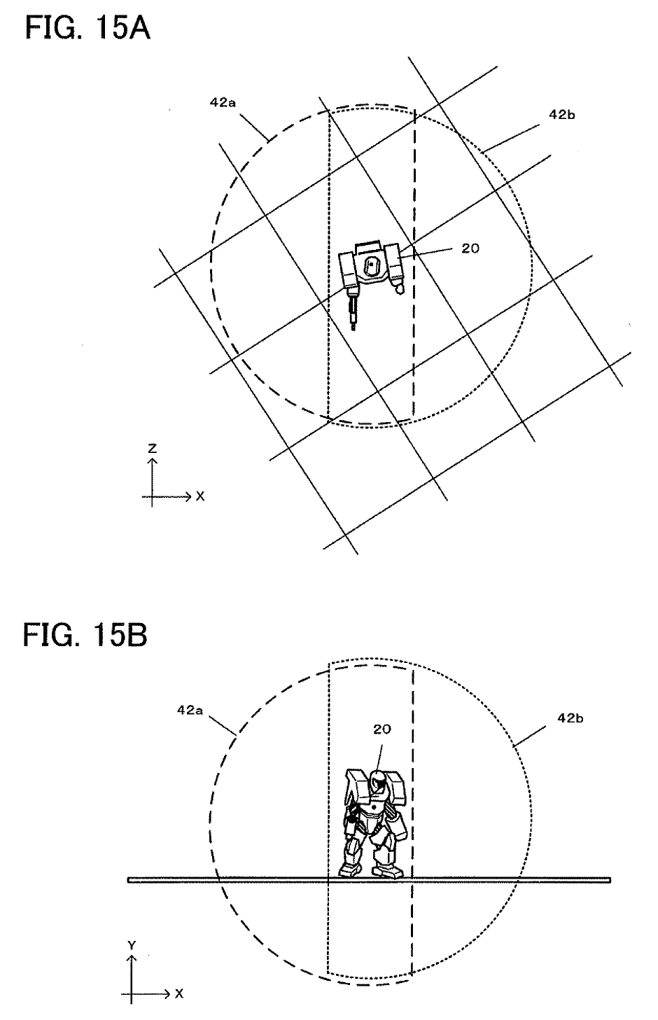

In FIGS. 15A and 15B, the enemy character 20 is divided into a right side part and a left side part. An approximately hemispherical area formed by dividing a spherical area around the position (representative point) of the enemy character 20 in a vertical plane along the back-and-forth direction of the enemy character 20 is set corresponding to each part as the rebound bullet target range. Specifically, an approximately hemispherical area 42a that includes the right side of the enemy character 20 and opens rightward is set corresponding to the right side of the enemy character 20, and an approximately hemispherical area 42b that includes the left side of the enemy character 20 and opens leftward is set corresponding to the left side of the enemy character 20. The area 42a is set to be the rebound bullet target range when a bullet has hit the right side of the enemy character 20, and the area 42b is set to be the rebound bullet target range when a bullet has hit the left side of the enemy character 20.

In the example shown in FIGS. 15A and 15B, the approximately hemispherical area is formed around the representative point of the enemy character 20. Note that a representative point may be defined corresponding to each of the right side and the left side of the enemy character 20. A rectangular parallelepiped area may be formed instead of a hemispherical area.

In the example shown in FIGS. 15A and 15B, the rebound bullet target ranges corresponding to the right side and the left side of the enemy character 20 have an equal size. Note that the rebound bullet target range corresponding to the right side of the enemy character 20 may be set to be larger than the rebound bullet target range corresponding to the left side of the enemy character 20 since the enemy character 20 holds the weapon with the right hand.

(B-3) Change in Rebound Bullet Target Range 40 Corresponding to Flight Direction of Attack Object

The rebound bullet target range 40 may be changed corresponding to the flight direction of the bullet (attack object). Specifically, an area that includes the enemy character 20 that has been hit by the bullet 14 and also includes the flight direction of the bullet 14 that travels toward the enemy character 20 is set as the rebound bullet target range 40.

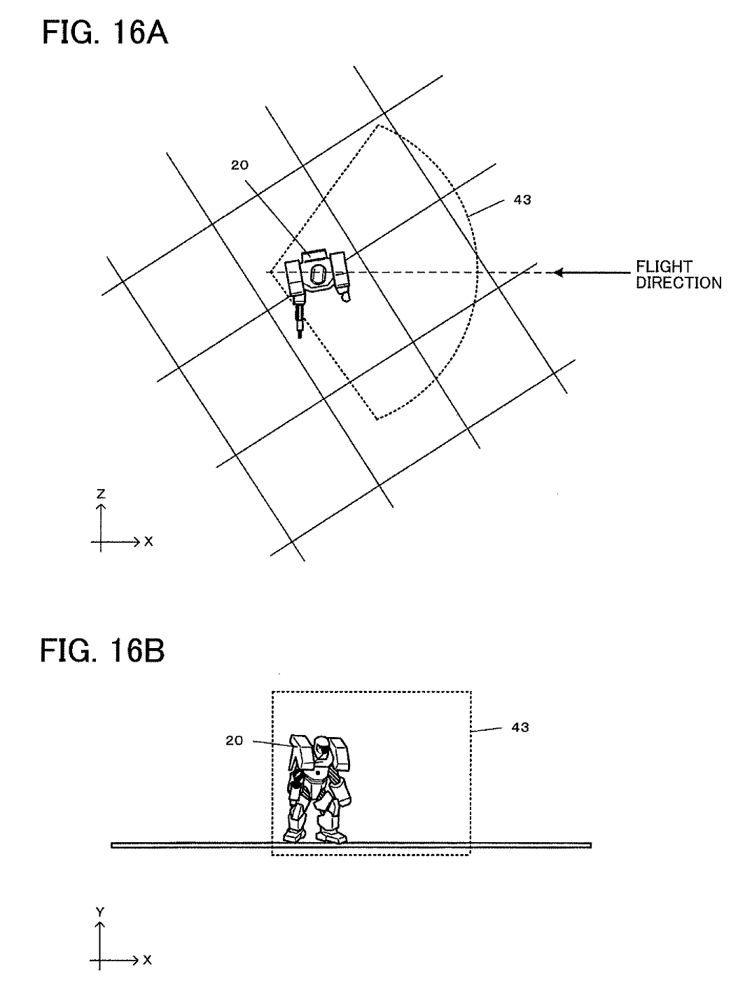

In FIGS. 16A and 16B, a pillar-shaped area that is fan-shaped when viewed from above is set as the rebound bullet target range 40. The rebound bullet target range 40 includes the representative point of the enemy character 20 near the center angle of the fan shape, and widens from the position of the enemy character 20 toward the bullet firing position (i.e., player's character 10). The center angle of the fan shape is divided in two by the flight direction of the bullet 14.

Note that the shape of the rebound bullet target range 40 is not limited to a fan shape shown in FIGS. 16A and 16B. The rebound bullet target range 40 may have a tubular or conical shape.

(B-4) Change in Rebound Bullet Target Range 40 Corresponding to Distance Between Player's Character 10 and Enemy Character 20

The rebound bullet target range 40 may be changed corresponding to the distance L between the position of the player's character 10 (or the bullet firing position) and the position of the enemy character 20 that has been hit by the bullet 14 (or the position of the surface of the enemy character 20 that has been hit by the bullet 14). Specifically, when the rebound bullet target range 40 has a spherical shape, the radius R of the spherical shape is changed corresponding to the distance L. For example, since the bullet more weakly rebounds as the distance L increases, the size of the rebound bullet target range 40 is reduced by reducing the radius R of the spherical shape. In this case, the rebound bullet target range 40 may or may not be changed corresponding to the type of the gun 12. Specifically, the radius R may be determined corresponding to the type of the gun 12 and the distance L, or may be determined corresponding to the distance L without taking account of the type of the gun 12. The shape of the rebound bullet target range 40 may be changed corresponding to the distance L.

(B-5) Change in Rebound Bullet Target Range 40 Corresponding to Player's Character 10

The rebound bullet target range 40 may be changed corresponding to the type of the player's character 10. Specifically, when the rebound bullet target range 40 has a spherical shape, the radius R of the spherical shape is changed corresponding to the type of the player's character 10. For example, when the player's character 10 has a good shooting skill (e.g., skilled soldier), the size of the rebound bullet target range 40 is increased by increasing the radius R so that a state in which the bullet 14 hits the enemy character 20 is displayed.

In this case, the rebound bullet target range 40 may or may not be changed corresponding to the type of the gun 12 held by the player's character 10. Specifically, the radius R may be determined corresponding to the type of the gun 12 and the type of the player's character 10, or may be determined corresponding to the type of the player's character 10 without taking account of the type of the gun 12. The rebound bullet target range 40 may have a shape corresponding to the type of the player's character 10.

When a plurality of (two or more) players play the game in the same game space, the rebound bullet target range 40 may be changed corresponding to the player's character 10 that has shot the enemy character.

(C) Hit Effect

(C-1) Difference Between Rebound Hit and Direct Hit

The above embodiments have been described taking an example in which the same hit effect is produced when the breakable object has been hit by a rebound bullet and when the breakable object has been directly hit by a bullet fired from the gun. Note that different hit effects may be produced. Specifically, the effect 52 and the replacement model 54 are defined as the hit effect data 633 corresponding to each hit count corresponding to each hit type (rebound hit or direct hit). When producing the hit effect, the effect 52 and the replacement model 54 corresponding to the current hit type (rebound hit or direct hit) are displayed.

(C-2) Damage Level

The above embodiments have been described taking an example in which the hit effect is produced corresponding to the current hit count of the breakable object. Note that the hit effect may be produced corresponding to the damage level caused by a bullet.

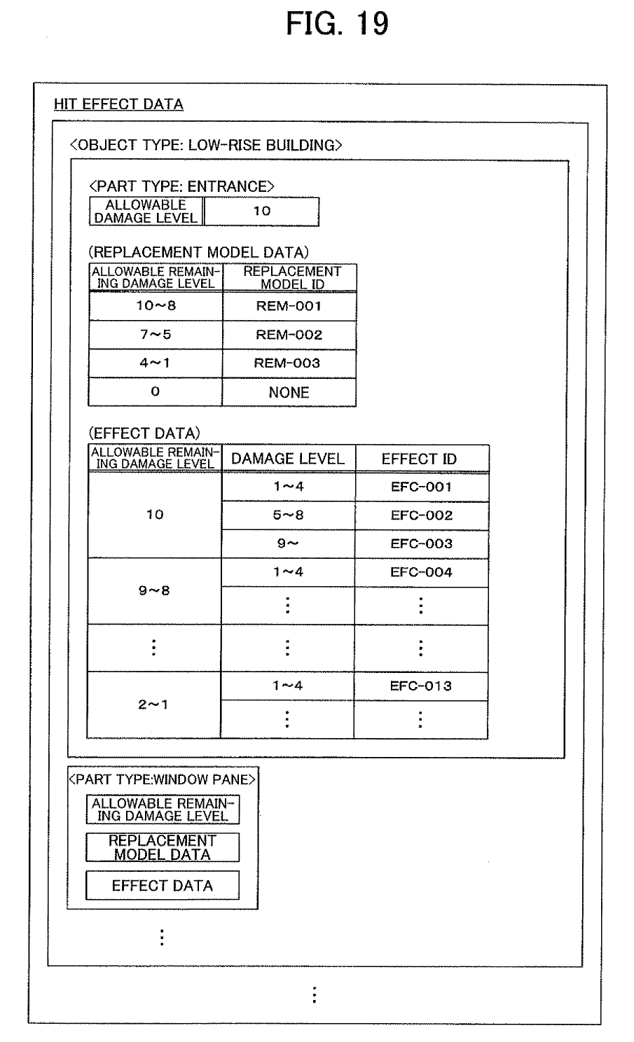

Specifically, the hit effect is produced according to hit effect data shown in FIG. 19 instead of the hit effect data 633. The hit effect data shown in FIG. 19 is generated corresponding to each type of object. An allowable damage level, replacement model data, and effect data are stored as the hit effect data corresponding to each type of part that forms the object.

The allowable damage level is the maximum value of the allowable remaining damage level, and is a value when the part has not been damaged (i.e., the initial state when the part is disposed in the game space). The allowable remaining damage level corresponds to the hit point of the character. The allowable remaining damage level decreases when the part has been damaged due to a bullet. The part has been completely broken when the allowable remaining damage level has become equal to or less than zero.

A replacement model ID is stored as the replacement model data corresponding to the allowable remaining damage level. The replacement model corresponding to each allowable remaining damage level has a shape in which an area of the part remains corresponding to the allowable remaining damage level.

A damage level and an effect ID are stored as the effect model data corresponding to the allowable damage level immediately before the part is hit by a bullet. A more attractive effect (e.g., a larger number of fragments are scattered farther) is produced as the damage level increases or the allowable damage level immediately before the part is hit by a bullet increases.

Specifically, the allowable remaining damage level of the breakage target part is reduced by the damage level caused by the bullet. The breakage target part is replaced by the replacement model corresponding to the allowable damage level, and the effect corresponding to the combination of the allowable remaining damage level immediately before the part is damaged and the damage level is displayed.

(D) Selection of Rebound Bullet Target Object

The above embodiments have been described taking an example in which the breakable object that is positioned within the rebound bullet target range 40 and positioned closest to the enemy character 20 is selected as the rebound bullet target object. Note that the rebound bullet target object may be selected under another condition (e.g., breakability), or may be selected randomly. In this case, when another object is positioned between the selected object and the enemy character 20 (i.e., a range that includes a straight line that connects the position of the selected object and the position of the enemy character 20 in which a rebound bullet travels), the other object may be selected as the rebound bullet target object instead of the selected object. This prevents an inconsistent situation (effect) in which the rebound bullet passes through the other object and hits the selected object positioned behind the other object.

(E) Successive Bullet Rebounds

The above embodiments have been described taking an example in which the bullet 14 that has hit the enemy character 20 rebounds from the enemy character 20 and hits another object (i.e., single rebound). Note that rebounds may successively occur a plurality of times. Specifically, the bullet 14 that has hit the enemy character 20 rebounds from the enemy character 20 and hits another object (first rebound), rebounds from the other object and hits another object (second rebound) (i.e., one bullet 14 successively rebounds and hits a plurality of objects). In this case, a successive bullet rebound finish condition may be satisfied (a) when a predetermined rebound bullet count (e.g., four) has been reached, or (b) when the object has been completely broken by the rebound bullet (i.e., the allowable damage level has become equal to or less than a given value), for example. The successive bullet rebound finish condition may be satisfied when the condition (a) or (b) is satisfied or the conditions (a) and (b) are satisfied (AND or OR).

In this case, damage to the rebound bullet target object may be decreased each time the bullet rebounds. In this case, (c) when the damage level applied to the rebound bullet target object has become equal to or less than a given level is additionally used as the successive bullet rebound finish condition. The damage level applied to the rebound bullet target object due to the first bullet rebound may be determined corresponding to the type of the gun 12, the type of the player's character 10, the distance L between the player's character 10 and the enemy character 20, or the like.

Specifically, when the damage level applied to the enemy character 20 that has been directly hit by the bullet 14 is “D₀”, the damage level caused by the first bullet rebound is D₁=D₀·n (<1.0), the damage level caused by the second bullet rebound is D₂=D₁n=D₀·n² (<1.0), and the damage level caused by the mth bullet rebound is Dₘ=D₀·n^{m} (<1.0). In this case, the effect and the replacement model corresponding to the damage and the allowable remaining damage level after the object has been hit by the bullet are displayed using the above-mentioned hit effect data (see FIG. 19).

(F) Game Device

The above embodiments have been described taking an example in which the arcade game device executes the gun shooting game. Note that the invention may also be applied to other game devices such as a consumer game device and a portable game device.

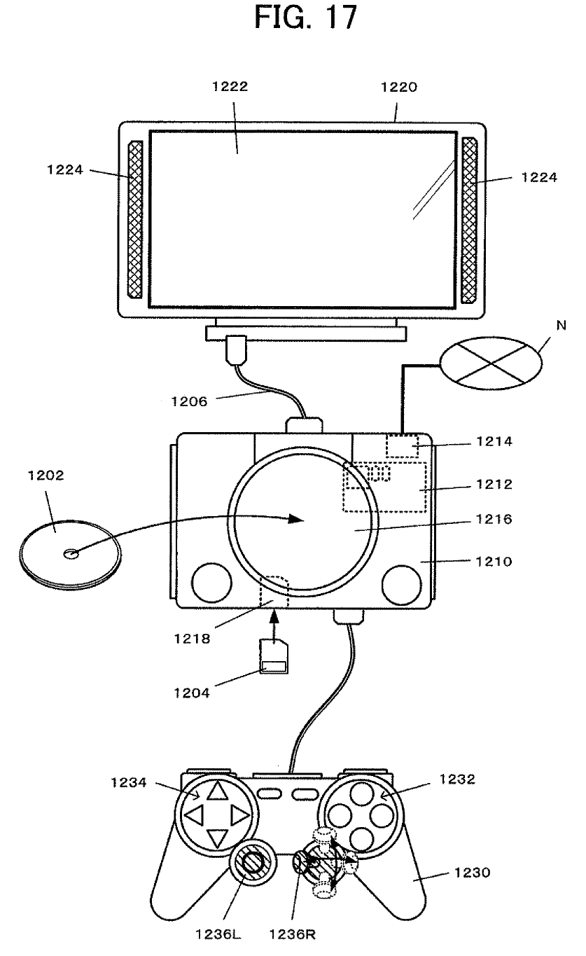

FIG. 17 is a schematic view showing an example of a consumer game device 1200. As shown in FIG. 17, the consumer game device 1200 includes a game device main body 1210, a video monitor 1220, and a game controller 1230. The game device main body 1210 includes a control unit 1212 provided with a CPU, an image processing LSI, an IC memory, and the like, and readers 1216 and 1218 for reading data from information storage media such as an optical disk 1202 and a memory card 1204. The control unit 1212 reads a game program and setting data from the optical disk 1202 and the memory card 1204, and executes various game calculations based on an operation input using the game controller 1230.

The control unit 1212 includes electric/electronic instruments such as various processors (e.g., central processing unit (CPU), graphics processing unit (GPU), and digital signal processor (DSP)), an application-specific integrated circuit (ASIC), and an IC memory, and controls each section of the consumer game device 1200. The control unit 1212 includes a communication device 1214 that connects to a communication channel N (e.g., Internet, local area network (LAN), or wide area network (WAN)), and implements data communication with an external device.

The game controller 1230 includes push buttons 1232 used for selection, cancellation, timing input, and the like, arrow keys 1234 used to individually input an upward, downward, rightward, or leftward direction, a right analog lever 1236R, and a left analog lever 1236L. When executing the gun shooting game, the operation (e.g., trigger operation or weapon change operation) of the player's character may be input using the push button 1232, and the position of the sight 2 may be moved upward, downward, rightward, or leftward using the left analog lever 1236L.

The control unit 1212 generates a game image and game sound based on a detection signal and an operation input signal received from the game controller 1230. The game image and the game sound generated by the control unit 1212 are output to the video monitor 1220 (display monitor) connected to the game device main body 1210 via a signal cable 1206. The video monitor 1220 includes a device 1222 that displays an image, and a speaker 1224 that outputs sound. The player plays the game while watching a game image displayed on the image display device 1222 and listening to a game sound output from the speaker 1224.

(C) Type of Game

The above embodiments have been described taking an example of executing the gun shooting game. Note that the invention may also be applied to other games.

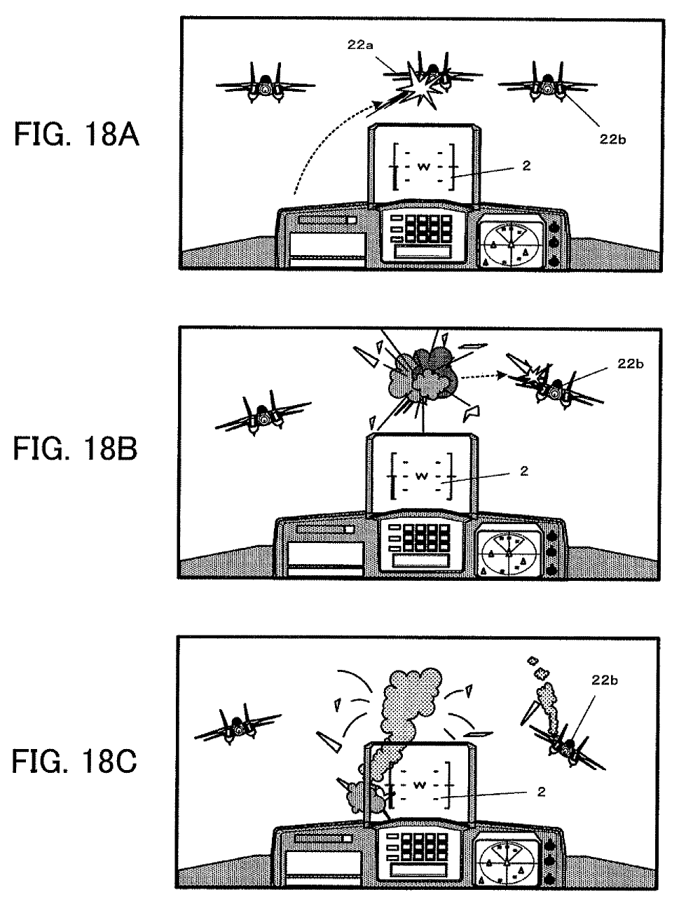

FIGS. 18A to 18C are views showing examples of a game screen when the invention is applied to a flight shooting game. As shown in FIGS. 18A to 18C, the game screen of the flight shooting game is displayed as a cockpit screen viewed from the viewpoint of a pilot of a player's aircraft (first person point of view). The player controls the player's aircraft by operating a controller. The player performs a shooting operation such as pulling a trigger in a state in which a sight 2 coincides with an enemy aircraft.

As shown in FIG. 18A, when the player has successfully shot an enemy aircraft 22a, the enemy aircraft 22a is damaged, goes up in flames, and breaks (see FIG. 18B). As shown in FIG. 18C, fragments scattering from the enemy aircraft 22a hit another enemy aircraft 22b positioned near the enemy aircraft 22a so that the enemy aircraft 22b is damaged and smoke occurs.

In the gun shooting game according to the above embodiments, an object that has been directly hit by the bullet as well as another object that has been hit by the bullet that has rebounded from the object are damaged. Note that scattering fragments may cause damage instead of a rebound bullet.

In FIGS. 4A to 4C, the enemy character 20 may be formed by breakable part objects (e.g., head, right arm, left arm, trunk, left leg, and right leg), for example. In FIG. 4B, the right arm of the enemy character 20 that has been hit by the bullet may be broken. In FIG. 4C, the wooden box may be damaged by fragments of the right arm that has broken instead of a rebound bullet. Specifically, the rebound bullet in the above embodiments may be replaced by scattering fragments.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A method of generating an image of a virtual three-dimensional space, a plurality of objects being disposed in the virtual three-dimensional space, the method comprising:
detecting that an attack object that flies in the virtual three-dimensional space has come in contact with an object among the plurality of objects; and
damaging another object among the plurality of objects that satisfies a given relative positional relationship with the object that has come in contact the attack object.

2. The method as defined in claim 1, further comprising:
causing the other object to break when the other object is a breakable object.

3. The method as defined in claim 2,
an allowable damage level being set corresponding to each of the plurality of objects;
the method further comprising:
decrementing an allowable remaining damage level of an object among the plurality of objects that has been damaged; and
causing the other object to break when the allowable remaining damage level of the other object is equal to or less than a given damage level.

4. The method as defined in claim 3, further comprising:
determining the damage level applied to the other object; and
causing the other object to break when the allowable remaining damage level of the other object is equal to or less than the determined damage level.

5. The method as defined in claim 4, further comprising:
successively executing a selection process that selects an object among the plurality of objects that satisfies a given relative positional relationship with the other object as a damaging target object; and
determining the damage level applied to the selected object and damaging the selected object each time the selection process is executed.

6. The method as defined in claim 5, further comprising:
gradually reducing the damage level applied to the selected object each time the selection process is executed.

7. The method as defined in claim 5, further comprising:
stopping the selection process based on the allowable remaining damage level of the object that has been damaged.

8. The method as defined in claim 2, further comprising:
executing a breakage effect process on the other object taking account of a direction from the object that has come in contact with the attack object to the other object.

9. The method as defined in claim 1, further comprising:
setting a search range having a given shape around the object that has come in contact with the attack object; and
selecting another object that is positioned within the search range as the damaging target object.

10. The method as defined in claim 9, further comprising:
disposing a virtual camera in the virtual three-dimensional space;
generating an image of the virtual three-dimensional space viewed from the virtual camera; and
setting the search range to be a cylindrical range that includes the object that has come in contact with the attack object and is disposed along a line-of-sight direction of the virtual camera.

11. The method as defined in claim 9, further comprising:
detecting a part of the object that has come in contact with the attack object; and
changing at least one of the size, shape, and direction of the search range corresponding to the detected part.

12. The method as defined in claim 9, further comprising:
detecting a flight direction of the attack object when the attack object has come in contact with the object; and
changing at least one of the size, shape, and direction of the search range corresponding to the detected flight direction.

13. The method as defined in claim 9,
a plurality of attack objects that differ in type being provided; and
the method further comprising:
changing the size of the search range corresponding to the type of the attack object that has come in contact with the object.

14. The method as defined in claim 9, further comprising:
disposing a character that can fire the attack object in the virtual three-dimensional space; and
changing the size of the search range corresponding to the character that has fired the attack object that has come in contact with the object.

15. The method as defined in claim 9, further comprising:
firing the attack object from a given firing position; and
changing the size of the search range corresponding to the distance between the firing position and a contact position where the attack object has come in contact with the object.

16. The method as defined in claim 9, further comprising:
selecting a given number of objects that are positioned within the search range in the order from an object that is positioned closest to the object that has come in contact with the attack object.

17. The method as defined in claim 16, further comprising:
changing the number of objects to be selected corresponding to the type of the attack object that has come in contact with the object.

18. The method as defined in claim 16, further comprising:
disposing a character that can fire the attack object in the virtual three-dimensional space; and
changing the number of objects to be selected corresponding to the character that has fired the attack object that has come in contact with the object.

19. A computer-readable information storage medium storing a program that causes a computer to execute the method as defined in claim 1.

20. A game device that generates an image of a virtual three-dimensional space and executes a given game, a plurality of objects being disposed in the virtual three-dimensional space, the game device comprising:
a firing section that fires an attack object based on an operation input by a player, the attack object flying inside the virtual three-dimensional space;
a detection section that detects that the attack object has come in contact with an object among the plurality of objects; and
a damaging section that damages another object among the plurality of objects that satisfies a given relative positional relationship with the object that has come in contact with the attack object.
